(19) United States
(12) Patent Application Publication
(10) Pub. No.: US 2003/0229853 A1
(43) Pub. Date: Dec. 11, 2003

(54) System and method for enabling client-manipulable morphing of HTML interfaces based on templates

(76) Inventors: Carl Norgren, Littleton, CO (US); Renee Wiens, Evergreen, CO (US)

Correspondence Address: BAKER & BOTTS, 30 ROCKEFELLER PLAZA, NEW YORK, NY, 10112

(21) Appl. No.: 10/394,295

(22) Filed: Mar. 21, 2003

Related U.S. Application Data
(60) Provisional application No. 60/366,682, filed on Mar. 21, 2002.

(51) Int. Cl. G06F 17/00

(52) U.S. Cl. 715/513

(57) ABSTRACT

A system and method for generating a client-specific version of an operational master HTML-based template, wherein the master template is hosted on a central server and is characterized by first display traits and first content traits. The method includes providing to a client computer through a demonstration area on the central server a client-manipulable version of the operational master template wherein at least one of the first display traits of first content traits may be altered by the client, and wherein the result of the alteration may be displayed substantially instantaneously on the client computer.

### CROSS-REFERENCE TO RELATED APPLICATION

This application claims priority based on U.S. Provisional Patent Application entitled “SYSTEM AND METHOD FOR ENABLING CLIENT-MANIPULABLE MORPHING OF HTML INTERFACES BASED ON TEMPLATES,” Serial No. 60/366,682, which was filed on Mar. 21, 2002.

### BACKGROUND OF THE INVENTION

It is desirable in the art of marketing and providing online informational, shopping, and product procurement functionality (e.g., through the Internet) to be able to achieve or offer co-branding. That is, often a provider of goods or services (e.g., mortgages or other financial services provider) will wish to partner with a re-seller of such goods or services (e.g., a marketer of mortgages who does not have its own loan origination and/or servicing capabilities or is not fully equipped or authorized to provide or produce the goods or services in question by itself). Thus, the re-seller may wish to re-sell the goods or services of the party actually originating them, but may wish further to do so under its own brand name or through its own facilities. In the case of products and services marketed online, the re-seller may wish to take advantage of all the online functionality enabled by the goods or services originator, but in a fashion or presentation that seamlessly presents to the end user or customer the impression that it is the re-seller who is the source or sponsor of the goods or services. For instance, a re-seller may wish to promote its company and brands as integrated and full-service in nature, even when, in reality, some of the goods and services sold by the re-seller (through its online website, for instance) actually originate with or are provided by a different company. This desire arises from the recognized commercial value of maintaining a unified brand image and unified look and feel for a particular company's online presence and overall advertising.

In the past, providing a central supplier's products and services to make them available to a broad range of re-sellers, especially re-sellers who wish to repackage and offer these products and services through their own online interface, but simultaneously using the pricing, information, and fulfillment functions and information of the central supplier's computer databases, sales and pricing engines, or other online or offline product and account databases and interfaces, has been difficult. In essence, the simplest way to achieve such multiple co-branded sites has been for the central supplier to build each site individually.

### DETAILED DESCRIPTION OF PREFERRED EMBODIMENTS

The present invention involves methods and systems for streamlining such processes. In accordance with the present invention, a basic website template containing functionality of and access to the databases and resources and basic online services of the central supplier may be superimposed with multiple visual facades (each chosen for a particular re-seller to reflect its desired look and feel or branding).

In another aspect of the invention, the re-sellers may in turn make their own-branded website available to additional re-sellers for sub-branding or additional own-branding. The invention accommodates such multiple re-brandings using a common HTML template that is user-configurable. Because the re-sellers may or may not have access to advanced technical services and personnel, the user configurable template of the present invention can be configured in highly user-friendly fashion (e.g., point and click or menu driven wizards may be provided for guiding the re-seller through the process of producing a customized re-seller HTML interface).

The present invention also sets forth automatic updating of all re-seller HTML interfaces/subsites when the basic functions, interactivity, databases, or other substantive content of the central template site are updated.

The present invention allows for extensive user-driven customization of re-seller subsites. For instance, substantially all aspects of screen appearance or aesthetic elements for the user sub-site may be configured (and previewed) by the re-seller, using a simple secured configuration website or portal, on a near-instantaneous basis. Fonts, colors, logos, and the arrangement of data fields may be custom configured, and additional re-seller-specific fields of data may be added, so long as the underlying basic functionality of the central server-originated supplier website is not substantially diminished or interfered with.

The user-configurable functions of the present invention may be hosted upon a development (or “non-live”) portion of the same website or host server used to host the functioning central supplier HTML interface. Thus, a number of re-sellers may have access to the user-configurable interface for altering, previewing, and selecting revised re-seller website interface options in real time without needing to download additional software and without affecting the “live” HTML interface of the re-seller accessible by the public until the changes in interface configuration are definitively approved by the re-seller following configuration and preview, at which point the re-seller interface/subsite will be automatically updated in its publicly-accessible form to reflect the new configuration, while not affecting the underlying functionality of the subsite or its substantive interaction with the central supplier's HTML or data interface.

The foregoing merely illustrates the principles of the invention. Various modifications and alterations to the described embodiments will be apparent to those skilled in the art in view of the teachings herein. It will thus be appreciated that those skilled in the art will be able to devise numerous techniques which, although not explicitly described herein, embody the principles of the invention and are thus within the spirit and scope of the invention.

We claim:

1. A method for generating a client-specific version of an operational master HTML-based template, wherein the master template is hosted on a central server and is characterized by first display traits and first content traits, the method comprising the steps of:
providing to a client computer through a demonstration area on the central server a client-manipulable version of the operational master template wherein at least one of the first display traits of first content traits may be altered by the client, and wherein the result of said alteration may be displayed substantially instantaneously on the client computer.

2. The method of claim 1, wherein the client is provided with the ability to manipulate any of said first display and said first content traits in any client-chosen sequence.

3. The method of claim 1, wherein substantially all pages of the template are changed.

4. The method of claim 1, wherein said step of client alteration of said traits comprises providing the client with an alteration wizard interface having logic rules.

5. The method of claim 1, further comprising the step of implementing said client alterations and an operation client-specific HTML Webster.

6. The method of claim 5, wherein said HTML website is hosted on the central server.

7. The method of claim 4, wherein said wizard interface comprises client-implementable point and click client options implementable by the client without, and provision of HTML coding performed by the client.

8. A method for generating a plurality of distinct HTML website versions based upon an operational generic template, the template comprising an HTML file and containing first display traits and first content traits, said method comprising the steps of:
(a) parsing the HTML file to produce a plurality of software objects each operational for expressing at least one HTML block;
(b) combining at least a plurality of said produced objects;
(c) presenting said combined produced objects through a plurality of unique resource managers to express resources required for definition of website display to content traits.

9. The method of claim 8, wherein said unique resource managers are configured with client-specific traits.

10. The method of claim 8, wherein at least some of said unique resource managers share at least a subset of common resources.

11. The method of claim 10, wherein said sharing of common resources results at least in part from inheritance.
